(19) United States
(12) Patent Application Publication
(10) Pub. No.: US 2025/0361119 A1
(43) Pub. Date: Nov. 27, 2025

(54) CONDITION MONITORING INSIDE AN ELEVATOR SHAFT OF AN ELEVATOR SYSTEM

(71) Applicant: Kone Corporation, Helsinki (FI)

(72) Inventors: Tommi HUOTARI, Helsinki (FI); Jimi Hytönen, Helsinki (FI); Matti Mustonen, Helsinki (FI); Matti Laakso, Helsinki (FI); Jouko Kinnari, Helsinki (FI)

(73) Assignee: Kone Corporation, Helsinki (FI)

(21) Appl. No.: 19/295,147

(22) Filed: Aug. 8, 2025

Related U.S. Application Data
(63) Continuation of application No. PCT/FI2023/050125, filed on Mar. 6, 2023.

(51) Int. Cl. B66B 7/12; B66B 3/00

(52) U.S. Cl. CPC B66B 7/1238; B66B 3/002

(57) ABSTRACT

An elevator system for monitoring a condition inside an elevator shaft of the elevator system if provide, the system comprises: at least one image sensor and a control unit configured to receive the image data from the at least one image sensor, and is further configured to: determine an indicator value indicative of a presence of foreign matter in the elevator shaft; compare the indicator value to a reference value; and set a detection result to express one of the following: (i) the condition inside the elevator shaft is acceptable, (ii) the condition inside the elevator shaft is unacceptable. Also a method, a control unit and a computer program are provided.

### CROSS-REFERENCE TO RELATED APPLICATION

This application is a continuation of PCT International Application No. PCT/FI2023/050125 which has an International filing date of Mar. 6, 2023, the entire contents of which are incorporated herein by reference.

### TECHNICAL FIELD

The invention concerns in general the technical field of elevators. More particularly, the invention concerns condition monitoring.

### BACKGROUND

Elevator systems are vulnerable to various shocks caused by external sources which may prevent a use of the elevator system. The term shock shall be understood in a broad manner and it may relate to events, or similar, occurring inside an elevator shaft. One source of the external shock may be foreign material ended up to the elevator shaft in one way or another. Typically, the foreign material ends up to the elevator shaft due to that visitors of the premises where the elevator system resides manage to throw trash into the elevator shaft or due to that the elevator system, or an entity of the building, leaks some fluid inside the elevator shaft. In some areas, the foreign material may refer to a water ended up to the elevator shaft e.g. due to flooding in the area. These kinds of events may cause e.g. safety risk, such as the foreign material inside the elevator shaft may catch fire, but also this cause additional work to maintenance personnel who needs to inspect the elevator shaft independently if there are foreign material or not. Due to this the maintenance personnel needs to be prepared for taking actions with respect to the foreign material, such as always carrying necessary cleaning materials and devices with them.

In order to optimize actions to be taken with respect to the elevator shaft there is a need to introduce novel approaches for conditioning monitoring of the elevator system.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An object of the invention is to present an elevator system, a method, a control unit and a computer program for monitoring a condition inside an elevator shaft of the elevator system.

The objects of the invention are reached by an elevator system, a method, a control unit and a computer program for monitoring a condition inside an elevator shaft of the elevator system as defined by the respective independent claims.

According to a first aspect, an elevator system for monitoring a condition inside an elevator shaft of the elevator system is provided, the system comprises:
at least one image sensor configured to generate image data from the elevator shaft of the elevator system,
a control unit configured to receive the image data from the at least one image sensor and further configured to:
   determine, on the basis of the image data, an indicator value indicative of a presence of foreign matter in the elevator shaft,
   compare the indicator value to a reference value, and
   set, in accordance with a comparison between the indicator value and the reference value, a detection result to express one of the following: (i) the condition inside the elevator shaft is acceptable, (ii) the condition inside the elevator shaft is unacceptable.

The control unit may e.g. be configured to generate an alarm signal in response to setting the detection result to express that the condition inside the elevator shaft is unacceptable. For example, the control unit may be configured to trigger with the generation of the alarm signal at least one of the following: a generation of a signal to a terminal device of a technician to indicate the condition inside the elevator shaft; a generation of a signal to prevent a use of the elevator system.

Furthermore, the control unit may be, in response to setting the detection result to express that the condition inside the elevator shaft is unacceptable, further configured to perform:
determining at least one characteristic of the foreign matter inside the elevator shaft,
comparing the at least one characteristic of the foreign matter to a number of definitions of foreign matter, and
generate a description of the foreign matter in response to a detection of a match between the at least one characteristic of the foreign matter and at least one definition of foreign matter.

The control unit may be configured to include the description of the at least foreign matter to the signal to the terminal device of the technician.

Moreover, the at least one image sensor may reside in at least one of the following: a bottom of an elevator car of the elevator system; a counterweight; a support structure arranged inside the elevator shaft.

The control unit may further be configured to, based on image data obtained with the at least one image sensor, determine a stretch of an elevator hoisting rope by:
determining a distance of the counterweight or the elevator car from a reference point,
compare the distance of the counterweight or the elevator car from the reference point to at least one reference value, and
generate an indication of the stretch of the elevator hoisting rope based on a result of the comparison.

Still further, the control unit may be configured to trigger a generation of the image data with the at least one image sensor by: in response to a receipt of a request from an external source; based on a predefined schedule. For example, the control unit may be configured to, prior to triggering of the generation of the image data, generate a control signal to cause at least one of: switching on at least one source of light residing in the elevator shaft; switching on at least one source of light residing at the bottom of the elevator car; switching on at least one source of light associated to the image sensor.

According to a second aspect, a method for monitoring a condition inside an elevator shaft of an elevator system is provided, the method, performed by a control unit, comprises:
receiving image data from the at least one image sensor configured to generate image data from the elevator shaft of the elevator system,
determining, on the basis of the image data, an indicator value indicative of a presence of foreign matter in the elevator shaft,
comparing the indicator value to a reference value, and
setting, in accordance with a comparison between the indicator value and the reference value, a detection result to express one of the following: (i) the condition inside the elevator shaft is acceptable, (ii) the condition inside the elevator shaft is unacceptable.

Also an alarm signal may be generated in response to setting the detection result to express that the condition inside the elevator shaft is unacceptable. At least one of the following is triggered with the generation of the alarm signal: a generation of a signal to a terminal device of a technician to indicate the condition inside the elevator shaft; a generation of a signal to prevent a use of the elevator system.

Furthermore, in response to setting the detection result to express that the condition inside the elevator shaft is unacceptable the method may further comprise:
determining at least one characteristic of the foreign matter inside the elevator shaft,
comparing the at least one characteristic of the foreign matter to a number of definitions of foreign matter, and
generate a description of the foreign matter in response to a detection of a match between the at least one characteristic of the foreign matter and at least one definition of foreign matter.

The description of the at least foreign matter may be included to the signal to the terminal device of the technician.

Moreover, the method may further comprise a determination of a stretch of an elevator hoisting rope based on image data obtained with the at least one image sensor by:
determining a distance of the counterweight or the elevator car from a reference point,
compare the distance of the counterweight or the elevator car from the reference point to at least one reference value, and
generate an indication of the stretch of the elevator hoisting rope based on a result of the comparison.

A generation of the image data with the at least one image sensor may be triggered by: in response to a receipt of a request from an external source; based on a predefined schedule. For example, prior to triggering of the generation of the image data, a control signal may be generated to cause at least one of: switching on at least one source of light residing in the elevator shaft; switching on at least one source of light residing at the bottom of the elevator car; switching on at least one source of light associated to the image sensor.

According to a third aspect, a control unit is provided, the control unit is configured to perform the method according to the second aspect as described above.

According to a fourth aspect, a computer program is provided, the computer program comprising instructions to cause the control unit according to the third aspect as defined above to execute the steps of the method according to second aspect as defined above.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an elevator system according to an example.

FIG. 2 illustrates schematically a method according to an example.

FIG. 3 illustrates schematically further aspects in relation to a method according to an example.

FIGS. 4A and 4B illustrate schematically further aspects in relation to an elevator system according to an example.

FIG. 5 illustrates schematically a control unit according to an example.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

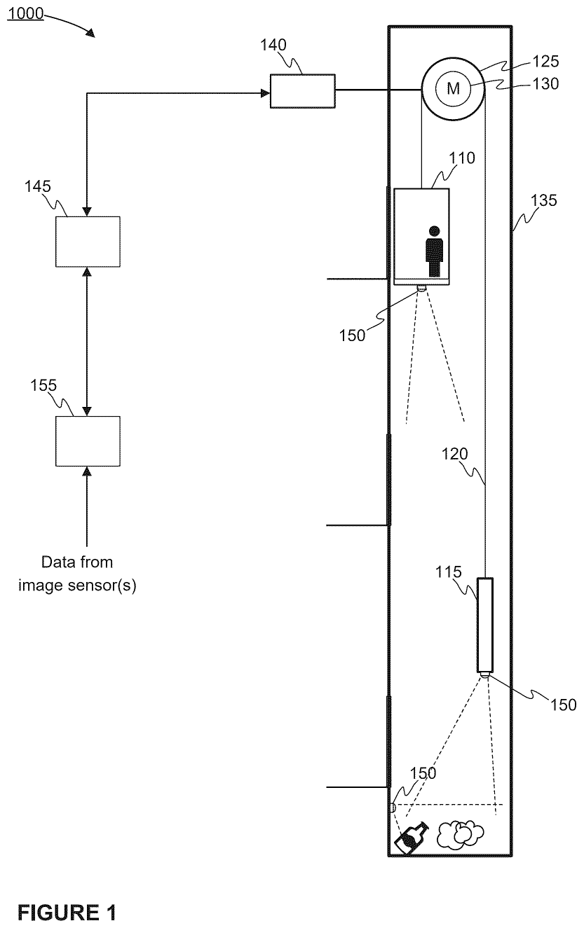

At least some aspects of the present invention relate to a condition monitoring of an elevator system. An example of the elevator system according to at least one embodiment of the invention is schematically illustrated in FIG. 1. The illustration of the elevator system 1000 in FIG. 1 is simplified and discloses only at least some entities of the elevator system 1000 according to the embodiment in order to describe at least some aspects in relation to the present invention. The elevator system 1000 comprises an elevator car 110 and a counterweight 115 connected to each other with an elevator hoisting rope 120 arranged to travel over a traction sheave 125 in a known manner. A rotation of the traction sheave 125 with a force generated by an electric motor 130 coupled to the traction sheave 125 causes at travel of the elevator car 110 and the counterweight 115 in an elevator shaft 135 in a known manner. The electric motor 130 is controlled with a drive system 140, which, in turn, is controlled with an elevator controller 145.

In accordance with the present invention the elevator system 1000 further comprises one or more image sensors 150 configured to generate image data from the elevator shaft 135 of the elevator system 1000. The image data shall be understood in a broad manner and it may be any data generated by the one or more image sensors 150 by means of which an analysis may be performed as is described in the forthcoming description. The image sensor(s) 150 may be mounted in various locations in the elevator system 1000. Generally speaking, image sensor 150 may preferably be arranged to the bottom section of the elevator shaft 135 in such way that the field of view (FOV) of the image sensor 150 at least partly comprises the bottom of the elevator shaft 135 and wherein the field of view of the respective image sensor 150 may also at least partly comprise a marker placed behind (seen from the direction of the image sensor 150) the counterweight 115 in its lowest position. The image sensor 150 is preferably installed on a support structure, such as on a wall of the elevator shaft 135, in such way that it does not interfere the operation of the elevator car 110 or the counterweight 115. The height of the image sensor 150 may preferably be substantially on a same level as the counterweight 115 at its lowest level or slightly above it. In FIG. 1 various locations of the image sensor(s) 150 are illustrated as non-limiting examples. The location may be on a wall of the elevator shaft 135 as the support structure, which refers to an inner wall of the elevator shaft 135. The term support structure shall be understood to cover also other solution, such as a dedicated stand for the image sensor 150 or any similar approach. Alternatively or in addition, the image sensor 150 may be mounted to the elevator car 110 and/or to the counterweight 115. Since the aim of the invention is to monitor a condition inside the elevator shaft 135, the at least one image sensor 150 may be configured to generate image data descriptive of a predefined space inside the elevator shaft 135. The space may advantageously be a bottom section of the elevator shaft 135 into which foreign matter accessed to the elevator shaft 135 gathers to as schematically illustrated in FIG. 1. The foreign material may refer e.g. to one or more trash items ended up to the elevator shaft 135 through various routes, but it may also refer to substance being disengaged from the elevator system 1000, or any other system inside the elevator shaft 135, or leaked from the elevator system 1000, such as oil or any other liquid.

The image sensor 150 installed in at least one of the locations mentioned in the foregoing description shall be understood as an entity suitable for generating image data descriptive of a target area. The image sensor 150 may be a camera device which may capture the images and possibly process, or pre-process, the image data and transmit the respective data to another entity. Additionally, it may store the image data either in a raw form or as a processed data as well as it may communicate with one or more external entities as is described in the forthcoming description. In a simplest form the image sensor 150 may only comprise the sensor unit readable from at least one external source. As non-limiting examples of the image sensor 150 a digital camera, a thermal camera, a hyperspectral camera and a time-of-fly (TOF) camera may be mentioned. The image sensor 150 may also be a radar or a sonar. The type of the image sensor 150 may be selected at least in part based on an object type under monitoring and/or the setup may comprise a plurality of different types of image sensors 150. In addition to the image sensor(s) 150 other types of sensors may be used for detecting further aspects in relation to the foreign matter in the elevator shaft 135. An example of such sensor(s) may be a gas detector by means of which it is possible to detect if the foreign matter in the elevator shaft 135 also generates gas.

As derivable from FIG. 1 as well as the foregoing description the number of image sensors 150 are arranged in the elevator system 1000 so that they may generate image data from the target area which preferably corresponds to the bottom area of the elevator shaft 135 i.e. the space in the bottom of the elevator shaft 135. Therefore, each image sensor 150 applied in the solution is arranged so that their focus area corresponds to the area of interest and mirrors and lens and any similar optical component may be applied in the arrangement. For example, the image sensor 150 mounted to the elevator car 110 or to the counterweight 115 is arranged so that its focus, or the sensing direction, is towards the bottom area of the elevator shaft 135 in order to generate image data from the respective area. Thus, advantageous location for the image sensor 150 in the elevator car 110 is the bottom of the elevator car 110 as shown in FIG. 1. Correspondingly, the image sensor 150 may advantageously be arranged at the bottom of the counterweight 115 as is also illustrated in FIG. 1. In case the image sensor 150 is mounted on the wall of the elevator shaft 135 as also shown in FIG. 1 as an alternative a mounting angle and/or a mounting height of the image sensor 150 shall be adjusted so that an image of the target area may be captured. Moreover, a field of view of the applied image sensors 150 shall be taken into account in the selection, or controlling, of the image sensors 150 so that the image sensor 150 is capable of capturing an image over the whole target area. Still further, in the imaging known methods, such as an adjustment of lens or an optimization of an instant of time of imaging, may be applied in order to set the focal point of the respective image sensor optimally with respect to the target area, and possible objects therein.

The measurement data, or the image data, captured by the one or more image sensors 150 may be carried to a control unit 155 over a communication channel arranged between the entities. The communication channel may be implemented either with wireless or wired communication technologies. The communication channel between the control unit 155 and the at least one image sensor 150 may be unidirectional or bidirectional wherein the latter provides means for controlling the image sensors 150 from the control unit 155, such as in order to instruct to capture one or more images at an instant of time and/or to transmit image data to the control unit 155, e.g. the image data stored in a memory used by the respective image sensor 150. The image sensors 150 are provided with electrical energy in order to operate with known techniques, such as provision of the electrical energy with applicable cabling or by arranging a battery for providing the electrical energy to the respective sensors.

The control unit 155 may be a computing device configured to perform a computer program causing the control unit 155 to operate in a manner as is described in the forthcoming description. Moreover, the control unit 155 may be communicatively connected to the elevator controller 145 so as to share information in a form of digital data between these. Even if the control unit 155 and the elevator controller 145 are illustrated as separate entities in FIG. 1, their operations may be integrated in the same computing entity. In case the control unit 155 is separate to the elevator controller 145 the control unit 155 may reside remotely to the premises the elevator system 1000 is implemented to operate.

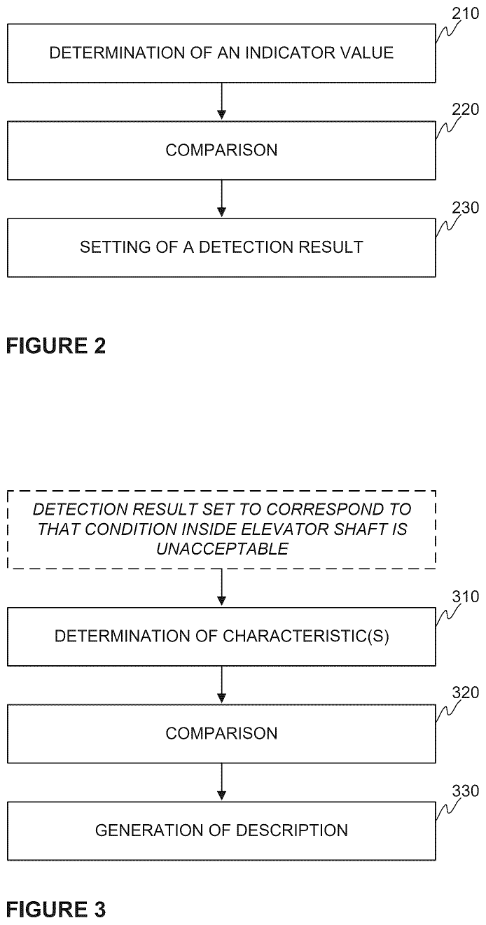

Next, further aspects in relation to the present invention are discussed by referring to FIG. 2. FIG. 2 illustrates schematically an example of a method according to an embodiment of the invention for monitoring a condition inside an elevator shaft 135 of the elevator system 1000. The method steps according to FIG. 1 may be executed by the control unit 155 of the elevator system 1000 arranged to receive the measurement data, i.e. the image data, from at least one image sensor 150 e.g. in an elevator system 1000 as schematically illustrated in FIG. 1.

First, the control unit 155 is configured to determine 210 an indicator value indicative of a presence of foreign matter in the elevator shaft 135 on a basis of the image data obtained from the at least one image sensor 150. In other words, the control unit 155 may receive automatically the image data captured by the at least one image sensor 150 or the control unit 155 may be arranged to inquire the image data in response to a predefined event, such as under a predefined schedule or a state of the elevator system 1000.

Depending on an implementation of the invention the control unit 155 may e.g. be configured to determine the indicator value by inserting the image data to an evaluation algorithm which generates a value indicative if there are foreign matter in the elevator shaft 135 or not. The evaluation algorithm may e.g. be configured to compare the image data to a reference image data and to generate an indicator value descriptive of a difference between the compared data. The reference image data may refer to a state that there are no foreign matter in the elevator shaft 135. Alternatively to that the evaluation algorithm may determine an indicator value descriptive of a bottom area, e.g. expressed as a percentage of the whole area, not being covered by the foreign matter, or vice versa (i.e. an amount of the bottom area being covered by the foreign matter).

For sake of completeness it is worthwhile to mention that the indicator value may consist of a plurality values descriptive of various features derivable from the image data which together describe the presence of foreign matter in the elevator shaft 135.

Any other approach for determining 210 the indicator value may be applied to as long as it in some manner describes the presence of foreign matter in the elevator shaft 135.

In response to the determination 210 of the indicator value the control unit 155 is configured to compare 220 the indicator value to a reference value. In case the indicator value consists of a plurality of values the reference value is advantageously construed in the same way, i.e. there is a dedicated reference value for each of the plurality of the values defining the indicator value. Thus, the comparison 220 is performed by comparing the values together and setting 230 a detection result accordingly. In other words, the detection result may be set 230 in accordance with the comparison 220 between the indicator value and the reference value and the detection result is set 230 by the control unit 155 either to express that the condition inside the elevator shaft 135 is acceptable or that the condition inside the elevator shaft 135 is unacceptable. The acceptable condition inside the elevator shaft 135 may refer to a situation in which the amount of foreign matter in the elevator shaft 135 is below an acceptable level defined with the reference value applied in the comparison 220. Correspondingly, the unacceptable condition may refer to a situation that it is detected that the amount of foreign matter in the elevator shaft 135 exceeds the acceptable level defined with the reference value applied in the comparison 220. The term “amount of foreign matter” shall be understood so that it also covers a situation that the foreign matter comprises a plurality types of foreign matter and at least one of them exceeds the acceptable level defined for the respective foreign matter(s).

In some example embodiments the monitoring of the condition inside an elevator shaft 135 of the elevator system 1000 may be based on an application of a machine-learning model for classifying the image data from the at least one image sensor 150. The machine-learning model may be trained to classify images so that the detection result as described above may be expressed. In other words, the model is configured to determine 210 the indicator value from the image data in order to perform the classification corresponding to the comparison step 220 in FIG. 2 and to generate the detection result as an output.

Due to that the foreign matter in the elevator shaft 135 may generate a safety risk, the control unit 155 may be configured to take measures especially in a situation that the detection result expresses that the condition inside the elevator shaft 135 is not acceptable. In accordance with an example embodiment the control unit 155 may be configured to generate an alarm signal in response to setting the detection result to express that the condition inside the elevator shaft is unacceptable. For example, the generation of the alarm signal may e.g. trigger at least one of the following: a generation of a signal to a terminal device of a technician to indicate the condition inside the elevator shaft 135; a generation of a signal to prevent a use of the elevator system 1000. In the former case the control unit 155 may be provided with instructions to generate the signal to the terminal device wherein the instruction may comprise data defining one or more contact details and connection types of the terminal device, such as a telephone number or an email address or anything similar by means of which the technician carrying the terminal device may be reached. Additionally, the instructions may comprise data defining a message transmitted to the terminal device wherein the message may e.g. define the elevator system 1000 in which the condition of the elevator shaft 135 is not acceptable as well as any further information, such as data descriptive of the foreign matter detected inside the elevator shaft 135. The generation of the signal to the terminal device of the technician may also be arranged to occur indirectly, e.g. so that the alarm signal is first generated from the control unit 155 to a data centre, such as to a building management system or to a service centre of the elevator system 1000, from where the signal is delivered to the terminal device of the technician either in the original form or in a modified form. Alternatively or in addition, the control unit 155 may be configured to trigger a generation of the signal to prevent the use of the elevator system 1000 in relation to the generation of the alarm signal. In such an implementation the control unit 155 may be configured to generate the signal to the elevator controller 145 wherein the signal carries data indicating to the elevator controller 145 that the use of the elevator system 1000 shall be prevented. In response to a receipt of such piece of data the elevator controller 145 may be configured to take necessary measures to prevent the use of the elevator system 1000. Such measures may e.g. comprise an activation of the safety circuit so that the elevator system 1000 cannot be operated. Prior to that the elevator car 110 may be instructed to travel to a predefined floor e.g. for enabling an exit of passengers, if any, from the elevator car 110.

In some further example embodiments a sophisticated approach may be introduced in which an aim is to identify at least part of the foreign matter detected to be present in the elevator shaft 135. Such an approach is schematically illustrated in FIG. 3. Namely, in the method as described above the result is either that it is detected that the condition inside the elevator shaft 135 is acceptable or that the condition inside the elevator shaft 135 is unacceptable. The result is determined based on the information descriptive of a presence of foreign matter in the elevator shaft 135. In case the detection result is set 230 to express that the condition inside the elevator shaft 135 is unacceptable the control unit 155 may further be configured to determine a content of the foreign matter in the elevator shaft 135 with the method illustrated in FIG. 3. First, the control unit 155 may be configured to determine 310 at least one characteristic of the foreign matter inside the elevator shaft 135 from the image data. The at least one characteristic may e.g. be colour, shape, size, form or anything similar, and any combination of these. In response to the determination of the one or more characteristics the control unit 155 may be configured to compare 320 the at least one characteristic of the foreign matter to a number of definitions of foreign matter stored in data storage accessible by the control unit 155. In other words, the control unit 155 may be arranged to access data defining various foreign matters with one or more characteristics of the respective foreign matters and the definitions provide a way to identify the subject-matter, i.e. the foreign matter, inside the elevator shaft 135. The data defining the various foreign matters may also comprise descriptions for the various foreign matters, i.e. describing the foreign matter at some accuracy. For example, such a description may e.g. be “a green bottle” or “a paper” or “liquid” as non-limiting examples. Thus, the control unit 155 may be configured to generate 330 a description of the foreign matter in response to a detection of a match between the at least one characteristic of the foreign matter and at least one definition of foreign matter. The term match herein refers to an approach in which the match is considered to occur when the at least one characteristic corresponds to the at least one definition with a predefined confidence level, i.e. the probability is high enough. In some embodiments, the description may be included to the signal transmitted from the control unit 155 to any external entity, such as to the terminal device of a technician. In such a way the technician may prepare with appropriate tools and substances for the visit to the site the elevator system 1000 resides.

The above given method may further comprise, prior to the determination of the characteristics 310 a step in which the control unit 155 is configured to identify from the image data one or more objects determined to belong to the foreign matter. In other words, the content of the foreign matter is identified in a manner that one or more objects are identified from the foreign matter and the method of FIG. 3 is applied separately to each of the identified objects. Thus, the outcome of such an approach is that the control unit 155 may be configured to generate 330 the description so that it comprises data descriptive of each of the identified object(s) from the image data. In order to identify the one or more objects the control unit 155 may e.g. be configured to apply pattern recognition, and/or any other known detection algorithms, to the image data in order to determine the content of the foreign matter. Advantageously, the applied detection algorithm may also provide information on a location of the objects in the image and, thus, in the elevator shaft 135.

The invention as described in the foregoing description with some example embodiments may be applied for further use as is now described. Namely, as mentioned the image sensors 150 may be mounted to various locations in the elevator system 1000, such as at the bottom of the elevator car 110, to the counterweight 115 and/or to the wall of the elevator shaft 135. This allows a monitoring of a possible stretching of an elevator hoisting rope 120 in various manner as described in the following.

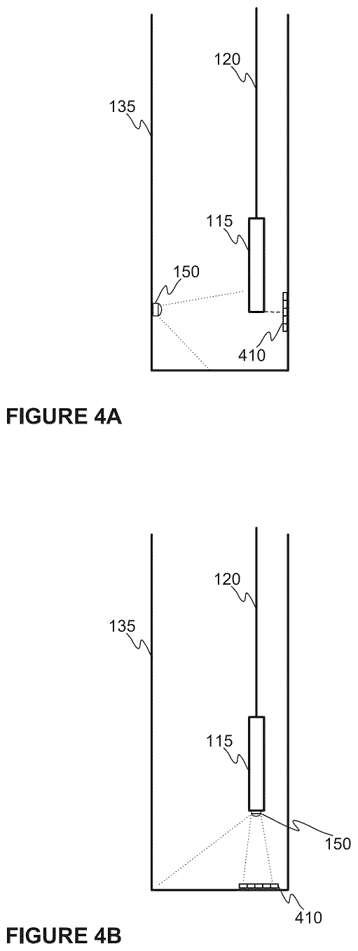

In a case the at least one image sensor 150 is mounted to the wall of the elevator shaft 135 the control unit 155 may be further configured to, based on the image data obtained with the at least one image sensor 150 residing on the wall of the elevator shaft, determine a stretch of an elevator hoisting rope 120 e.g. with an arrangement as shown in FIG. 4A. The arrangement may comprise, in addition to the previously described entities, a reference scale 410 arranged in an area from which the image sensor 150 mounted on the wall of the elevator shaft 135 is arranged to capture image data and so that the counterweight 115 may be instructed to locate between the respective image sensor 150 and the reference scale 410. The reference scale 410 may be implemented as an entity, such as a measuring scale, mountable to an appropriate location on the wall of the elevator shaft 135 or as markings performed on the wall of the elevator shaft 135. Thus, by capturing an image with the image sensor 150 the reference scale may be identified from the image data so as to detect a position, such as a height, of the counterweight 115 in the elevator shaft 135. In other words, the reference scale 410 may define one or more reference points by means of which the control unit 155 may be configured to determine a distance of the counterweight 115 in a vertical direction from a certain reference point at the time of the measurement. The way to determine the distance is dependent on the sensor applied in the implementation and the operation of the sensor itself may generate the data descriptive of the distance. For example, in case the applied image sensor 150 is the TOF sensor, the refence point may be defined as a predefined shape, or similar, which may be used in the determination of the distance. Now, the control unit 155 may be arranged with an access to a reference value and compare the measured value, i.e. the distance from the reference point, to the reference value. If these two deviate it may be concluded that the length of the elevator rope 120 has changed during a course of operation of the elevator shaft 135. The reference point may be considered as a zero point defined e.g. when the elevator system 1000 is taken into use or when the elevator rope 120 is renewed and the deviation to that is determined with the method as described. The reference point may also be linked to other point than one established with the reference scale 410. For example, in some embodiments the reference point may be set to correspond to the bottom of the elevator shaft 135 and the change in distance to that may be monitored. Furthermore, in some embodiments the stretching of the hoisting rope 120 may be measured by using the elevator car 110 instead of the counterweight 115 as the vehicle for determining the distance from the reference point in the vertical direction. Then, a level defined e.g. by the bottom of the elevator car 110 may be used as the level applied in the determination of a change with respect to the reference point in the vertical direction, for example. Generally speaking, the control unit 155 may be arranged to generate an indication of the stretch of the elevator hoisting rope 120 based on a result of the comparison as described above and the indication may be delivered to one or more predefined entities, such as to a terminal device of a technician. Based on the above, the present invention has a further advantage because it also enables elevator rope 120 condition monitoring as a part of the monitoring of the condition inside the elevator shaft 135 of the elevator system 1000.

On the other hand, if the image sensor(s) resides at the bottom of either the elevator car 110 or the counterweight 115 the one or more reference points may be positioned on the bottom of the elevator shaft 135 as shown in FIG. 4B. In FIG. 4B the reference point(s) are implemented with a corresponding reference scale 410 as shown in FIG. 4A. Now, the image sensor 150 arranged in the counterweight in the manner as shown in FIG. 4B may capture image on the reference points and any variation in a distance between the reference points determinable from the image data may be considered to occur due to a change in the length of the elevator hoisting rope 120, i.e. due to the stretching. Here, it is assumed that the settings in relation to the imaging are maintained the same, and/or correspond to any assumption used in defining any reference value. In case the image sensor 150 is a type of radar or similar the distance from the reference point, such as from the bottom of the elevator shaft 135 may be determined in a known manner based on data relating to a reflection, e.g. time difference between a transmit and a receipt of signal, and applied in a determination, e.g. through a comparison to a reference value, if the elevator hoisting rope 120 has experienced stretching. In general, the determination of the distance may be performed by applying known methods thereto, such as interpolation or extrapolation. For example, on the bottom of the elevator shaft 135 a predefined shape may be arranged and reference dimensions of it may be defined by capturing a reference image from a known level. Thus comparing data obtainable from later captured images with the reference data, any change in the distance may be determined. As is known, the dimensions may be determined in a pixel-wise manner from the captured images.

The above described application of monitoring also the length of the elevator rope 120, and its stretching, may be arranged to occur continuously during the operation of the elevator system 1000 e.g. when the counterweight 115 is identified from the image data or it may be performed under control, such as when the elevator controller 145 requests it from the control unit 155.

Still further, some aspects of the invention may relate to a timing of a generation of the image data in an advantageous way. In accordance with an embodiment of the invention the control unit 155 may be configured to trigger the generation of the image data with the at least one image sensor 150 in response to a receipt of a request from an external source. The external source may e.g. be the terminal device of the technician or it may be an entity, such as a server device, of a maintenance company of the elevator system 1000. Alternatively or in addition, the control unit 155 may be configured to trigger the generation of the image data with the at least one image sensor 150 based on a predefined schedule. The scheduling may be based on an instant of time, i.e. the image data is generated for analysis in once a week, but the scheduling may also be made dependent on one or more predefined events. An example of such an event may be a position of an entity belonging to the elevator system 1000. For example, if the image sensor 150 is mounted to the elevator car 110 and/or to the counterweight 115, the generation of the image data may be triggered to occur at a predefined distance from the area of interest, i.e. from the bottom of the elevator shaft 135. The predefined distance may refer to an optimal distance based on capabilities of the image sensor 150 to capture images with a required accuracy to conduct the analysis. In other words, the control unit 155 may be arranged to generate a control signal to trigger the image capturing with the one or more image sensors 150 in response to that the condition(s) as defined is fulfilled.

In accordance with some example embodiments the control unit 155 may be configured to optimize the conditions for the generation of the image data prior to that the image data is captured with the at least one image sensor 150. The optimization of the conditions for the generation of the image data may refer to a generation of a control signal to control lighting conditions in the elevator shaft 135 so as to optimize a quality of the image data. Thus, the control unit 155 may be configured to generate a control signal to cause at least one of: switching on at least one source of light residing in the elevator shaft 135; switching on at least one source of light residing at the bottom of the elevator car 110; switching on at least one source of light associated to the image sensor 150. The triggering of the switching on of the source(s) of light shall be arranged to occur prior to the generation of the image data and, therefore, the control unit 155 is arranged to generate the respective control signals in an order that the lighting conditions are set as desired prior to capturing of the image in the elevator shaft 135.

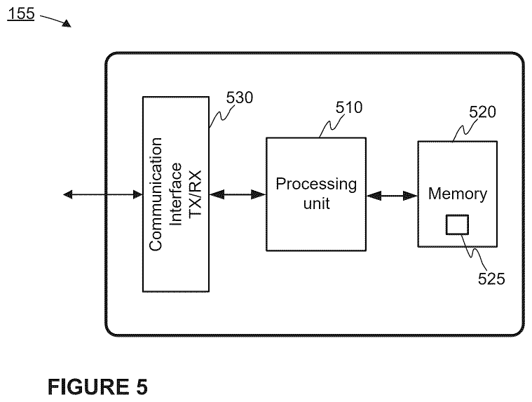

An example of an apparatus configurable to implement the operation of the control unit 155 is schematically illustrated in FIG. 5. The control unit 155 may be configured to perform the method according to the invention as described with the examples in the foregoing description. Thus, the apparatus of FIG. 5 may be configured to perform a monitoring of a condition inside an elevator shaft 135 of the elevator system 1000. For sake of clarity, it is worthwhile to mention that the block diagram of FIG. 5 depicts some components of an entity that may be employed to implement a functionality of the apparatus. The apparatus of FIG. 5 comprises a processor 510 and a memory 520. The memory 520 may store data, such as pieces of data as described, but also computer program code 525 causing the operation in the described manner. The apparatus may further comprise a communication interface 530, such as a wireless communication interface or a communication interface for wired communication, or both to communicate with other entities as described. The communication interface 530 may thus comprise one or more modems, antennas, and any other hardware and software for enabling an execution of the communication e.g. under control of the processor 510. Furthermore, I/O (input/output) components may be arranged, together with the processor 510 and a portion of the computer program code 525, to provide a user interface for receiving input from a user, such as from a technician, and/or providing output to the user of the apparatus when necessary. In particular, the I/O components may include user input means, such as one or more keys or buttons, a keyboard, a touchscreen, or a touchpad, etc. The I/O components may include output means, such as a loudspeaker, a display, or a touchscreen. The components of the apparatus may be communicatively connected to each other via data bus that enables transfer of data and control information be-tween the components.

The memory 520 and at least a portion of the computer program code 525 stored therein may further be arranged, with the processor 510, to cause the apparatus to perform at least a portion of a method as is described herein. The processor 510 may be configured to read from and write to the memory 520. Although the processor 510 is depicted as a respective single component, it may be implemented as respective one or more separate processing components. Similarly, although the memory 520 is depicted as a respective single component, it may be implemented as respective one or more separate components, some, or all of which may be integrated/removable and/or may provide permanent/semi-permanent/dynamic/cached storage.

The computer program code 525 may comprise computer-executable instructions that implement functions that correspond to steps implemented in the method when loaded into the processor 510 of the respective control unit 155. As an example, the computer program code 525 may include a computer program consisting of one or more sequences of one or more instructions. The processor 510 is able to load and execute the computer program by reading the one or more sequences of one or more instructions included therein from the memory 520. The one or more sequences of one or more instructions may be configured to, when executed by the processor 510, cause the apparatus, such as a computer, to perform a method as described. Hence, the apparatus may comprise at least one processor 510 and at least one memory 520 including the computer program code 525 for one or more programs, the at least one memory 520 and the computer program code 525 configured to, with the at least one processor 510, cause the apparatus implementing the control unit 150 to perform the method.

The computer program code 525, or at least some portion of it, may be provided e.g. a computer program product comprising at least one computer-readable non-transitory medium having the computer program code 525 stored thereon, which computer program code 525, when executed by the processor 510 causes the apparatus to perform the method. The computer-readable non-transitory medium may comprise a memory device or a record medium, such as a CD-ROM, a DVD, a Blu-ray disc, or another article of manufacture that tangibly embodies the computer program. As another example, the computer program may be provided as a signal configured to reliably transfer the computer program.

Still further, the computer program code 525 may comprise a proprietary application, such as computer program code for causing an execution of the method in the manner as described in the description herein.

Any of the programmed functions mentioned may also be performed in firmware or hardware adapted to or programmed to perform the necessary tasks.

For sake of completeness it is worthwhile to mention that the entity performing the method in the role of the control unit 155 may also be implemented with a plurality of apparatuses, such as the one schematically illustrated in FIG. 5, as a distributed computing environment corresponding to a control unit. For example, one of the apparatuses may be communicatively connected with the other apparatuses, and e.g. share the data of the method, to cause another apparatus to perform at least one other portion of the method. As a result, the method performed in the distributed computing environment generates the control signal indicative of the assignment of the responsibility as described. The functionalities of the control unit 155 as described may also be integrated to an entity also configured to perform other operations, such as the elevator controller 150.

The invention as described in the foregoing description has various advantages. Namely, the invention allows an optimization of resourcing in relation to the maintenance of the elevator system 1000 since the personnel needs not to visit the site regularly to check the situation in the elevator shaft. Merely, the personnel receives a notification upon a need to perform maintenance operation, i.e. cleaning, of the elevator system 1000. This also increases an operational time of the elevator system 1000. Moreover, at least some embodiments of the invention enable the personnel to prepare to the maintenance operation in an optimal way, since the foreign matter inside the elevator shaft 135 may be identified and, thus, the personnel may prepare the tools and other supplies accordingly for the visit to the site. Overall, safety of the elevator system 1000 may be increased since the operational conditions may be maintained in an improved level.

The specific examples provided in the description given above should not be construed as limiting the applicability and/or the interpretation of the appended claims. Lists and groups of examples provided in the description given above are not exhaustive unless otherwise explicitly stated.

What is claimed is:

1. An elevator system for monitoring a condition inside an elevator shaft of the elevator system, the system comprises:
at least one image sensor configured to generate image data from the elevator shaft of the elevator system,
a control unit configured to receive the image data from the at least one image sensor and further configured to:
determine, on the basis of the image data, an indicator value indicative of a presence of foreign matter in the elevator shaft,
compare the indicator value to a reference value, and
set, in accordance with a comparison between the indicator value and the reference value, a detection result to express one of the following: (i) the condition inside the elevator shaft is acceptable, (ii) the condition inside the elevator shaft is unacceptable.

2. The elevator system according to claim 1, wherein the control unit is configured to generate an alarm signal in response to setting the detection result to express that the condition inside the elevator shaft is unacceptable.

3. The elevator system according to claim 2, wherein the control unit is configured to trigger with the generation of the alarm signal at least one of the following: a generation of a signal to a terminal device of a technician to indicate the condition inside the elevator shaft; a generation of a signal to prevent a use of the elevator system.

4. The elevator system according to claim 1, the control unit is, in response to setting the detection result to express that the condition inside the elevator shaft is unacceptable, further configured to perform:
determining at least one characteristic of the foreign matter inside the elevator shaft,
comparing the at least one characteristic of the foreign matter to a number of definitions of foreign matter, and
generate a description of the foreign matter in response to a detection of a match between the at least one characteristic of the foreign matter and at least one definition of foreign matter.

5. The elevator system according to claim 4, wherein the control unit is configured to include the description of the at least foreign matter to the signal to the terminal device of the technician.

6. The elevator system according to any claim 1, wherein the at least one image sensor resides in at least one of the following: a bottom of an elevator car of the elevator system; a counterweight; a support structure arranged inside the elevator shaft.

7. The elevator system according to claim 1, the control unit is further configured to, based on image data obtained with the at least one image sensor, determine a stretch of an elevator hoisting rope by:
determining a distance of the counterweight or the elevator car from a reference point,
compare the distance of the counterweight or the elevator car from the reference point to at least one reference value, and
generate an indication of the stretch of the elevator hoisting rope based on a result of the comparison.

8. The elevator system according to claim 1, wherein the control unit is configured to trigger a generation of the image data with the at least one image sensor by: in response to a receipt of a request from an external source; based on a predefined schedule.

9. The elevator system according to claim 8, wherein the control unit is configured to, prior to triggering of the generation of the image data, generate a control signal to cause at least one of: switching on at least one source of light residing in the elevator shaft; switching on at least one source of light residing at the bottom of the elevator car; switching on at least one source of light associated to the image sensor.

10. A method for monitoring a condition inside an elevator shaft of an elevator system, the method, performed by a control unit, comprises:
receiving image data from the at least one image sensor configured to generate image data from the elevator shaft of the elevator system,
determining, on the basis of the image data, an indicator value indicative of a presence of foreign matter in the elevator shaft,
comparing the indicator value to a reference value, and
setting, in accordance with a comparison between the indicator value and the reference value, a detection result to express one of the following: (i) the condition inside the elevator shaft is acceptable, (ii) the condition inside the elevator shaft is unacceptable.

11. The method according to claim 10, wherein an alarm signal is generated in response to setting the detection result to express that the condition inside the elevator shaft is unacceptable.

12. The method according to claim 11, wherein at least one of the following is triggered with the generation of the alarm signal: a generation of a signal to a terminal device of a technician to indicate the condition inside the elevator shaft;
a generation of a signal to prevent a use of the elevator system.

13. The method according to claim 10, in response to setting the detection result to express that the condition inside the elevator shaft is unacceptable the method further comprises:
determining at least one characteristic of the foreign matter inside the elevator shaft,
comparing the at least one characteristic of the foreign matter to a number of definitions of foreign matter, and
generate a description of the foreign matter in response to a detection of a match between the at least one characteristic of the foreign matter and at least one definition of foreign matter.

14. The method according to claim 13, wherein the description of the at least foreign matter is included to the signal to the terminal device of the technician.

15. The method according to claim 10, the method further comprises a determination of a stretch of an elevator hoisting rope based on image data obtained with the at least one image sensor by:
determining a distance of the counterweight or the elevator car from a reference point,
compare the distance of the counterweight or the elevator car from the reference point to at least one reference value, and
generate an indication of the stretch of the elevator hoisting rope based on a result of the comparison.

16. The method according to claim 10, wherein a generation of the image data with the at least one image sensor is triggered by: in response to a receipt of a request from an external source; based on a predefined schedule.

17. The method according to claim 16, wherein, prior to triggering of the generation of the image data, a control signal is generated to cause at least one of: switching on at least one source of light residing in the elevator shaft; switching on at least one source of light residing at the bottom of the elevator car; switching on at least one source of light associated to the image sensor.

18. A control unit configured to perform the method according to claim 10.

19. A computer program comprising instructions to cause a control unit to execute the steps of the method according to claim 10.
